(19) United States
(12) Patent Application Publication
(10) Pub. No.: US 2021/0066998 A1
(43) Pub. Date: Mar. 4, 2021

(54) VIBRATION MOTOR

(71) Applicant: VIBRANT LTD., Yokneam (IL)

(72) Inventor: Shai Molnar, Shorashim (IL)

(21) Appl. No.: 17/008,697

(22) Filed: Sep. 1, 2020

(30) Foreign Application Priority Data
Sep. 1, 2019 (GB) 1912553.3

(51) Int. Cl. H02K 7/06; H02K 5/22

(52) U.S. Cl. CPC H02K 7/063; H02K 5/225

(57) ABSTRACT

A vibration motor, including a shell defining a cavity therein, an axis disposed entirely within the cavity, a first magnet which is rotationally movable relative to the shell and which includes at least two sections having alternating poles, and a second magnet including at least two sections having alternating poles. A first extension tab is attached to the first magnet and extends out of the shell via a slot. An unbalanced rotor is disposed between the first and the second magnets and is rotatable relative to the axis. The first extension tab is movable within the slot, such that moving the tab causes movement of the first magnet and changes a rotational position of the first magnet relative to the second magnet, thereby to change the efficiency of operation of the motor.

### FIELD OF THE INVENTION

The present invention relates in general to vibration motors for electronic devices, and specifically to vibration motors rotating using the force of magnetic fields.

### SUMMARY OF THE INVENTION

In accordance with an embodiment of the present invention, there is provided a vibration motor, including:

a shell defining a cavity therein;

an axis disposed entirely within the cavity and fixedly anchored to the shell;

a first magnet, disposed about the axis within the cavity and being rotationally movable relative to the axis and to the shell, the first magnet including at least two sections having alternating poles;

a second magnet, disposed about the axis within the cavity, the second magnet including at least two sections having alternating poles;

a first extension tab, fixedly attached to the first magnet and extending out of the shell via a slot in the shell;

an unbalanced rotor, disposed on the axis between the first and the second magnets and being rotatable relative to the axis, the unbalanced rotor having a commutating electronic circuit disposed on a first surface thereof and electric coils disposed on a second surface thereof, opposed to the first surface, the electric coils adapted to receive current from the commutating electronic circuit;

an electric terminal disposed about the axis within the cavity, the electric terminal including an electric circuit terminating in an electric lead extending out of the shell, and a plurality of brushes extending from the electrical terminal toward the unbalanced rotor and electrically engaging the commutating electronic circuit of the rotor, the plurality of brushes adapted to provide electric current, received via the electric lead, to the commutating electronic circuit,

wherein the first extension tab is movable within the slot, such that moving the tab causes rotation of the first magnet about the axis and changes a rotational position of the first magnet relative to the second magnet, thereby to change the efficiency of operation of the motor, and

wherein, in operation, DC current provided via the electric terminal and the brushes to the commutating electronic circuit causes polarizing of the coils, and attraction and repulsion of the polarized coils by the first and second magnets drives rotation of the rotor about the axis.

In accordance with an embodiment of the present invention, there is further provided a vibration motor, comprising:

a shell defining a cavity therein;

an axis disposed entirely within the cavity and fixedly anchored to the shell;

a first magnet, disposed about the axis within the cavity and being rotationally movable relative to the axis and to the shell, the first magnet including at least two sections having alternating poles;

a second magnet, disposed about the axis within the cavity, the second magnet including at least two sections having alternating poles;

a first extension tab, fixedly attached to the first magnet and extending out of the shell via a slot in the shell;

an unbalanced rotor, disposed on the axis between the first and the second magnets and being rotatable relative to the axis, the unbalanced rotor having a commutating electronic circuit disposed on a first surface thereof and electric coils disposed on a second surface thereof, opposed to the first surface, the electric coils adapted to receive current from the commutating electronic circuit;

an electric terminal disposed about the axis within the cavity, the electric terminal including an electric circuit terminating in an electric lead extending out of the shell, and a plurality of brushes extending from the electrical terminal toward the unbalanced rotor and electrically engaging the commutating electronic circuit of the rotor, the plurality of brushes adapted to provide electric current, received via the electric lead, to the commutating electronic circuit,

wherein, in a set-up mode of operation prior to activation of the vibration motor, the first extension tab is movable within the slot, such that moving the tab causes rotation of the first magnet about the axis and changes a rotational position of the first magnet relative to the second magnet, thereby to change the efficiency of operation of the motor, and in an active mode of operation of the vibration motor, following activation thereof, the first extension tab is fixed within the slot and the first magnet is fixed relative to the second magnet,

wherein, in operation, DC current provided via the electric terminal and the brushes to the commutating electronic circuit causes polarizing of the coils, and attraction and repulsion of the polarized coils by the first and second magnets drives rotation of the rotor about the axis.

In some embodiments, the second magnet is in a fixed rotational position relative to the shell. In some such embodiments, the first extension tab is adapted to move the first magnet between a lower motor efficiency orientation, in which a North pole of the first magnet at least partially overlaps a North pole of the second magnet, and a maximal motor efficiency orientation, in which there is no overlap of the North pole of the first magnet and the North pole of the second magnet.

In some embodiments, the first extension tab is adapted to move the first magnet between multiple lower motor efficiency orientations, wherein different ones of the multiple lower motor efficiency orientations have different degrees of overlap between the North pole of the second magnet and the North pole of the first magnet.

In some other embodiments, the second magnet is rotationally movable relative to the shell and relative to the first magnet.

In some such embodiments, the vibration motor further includes a second extension tab, fixedly attached to the second magnet and extending out of the shell via a second slot in the shell, and the first and second extension tabs are movable within the first and second slots, such that moving at least one of the first and second tabs causes relative movement of at least one of the first and second magnets and changes a relative position of the first and second magnets, thereby to change the efficiency of operation of the motor.

In some embodiments, at least one of the first and second extension tabs is adapted to move at least one of the first and second magnets between a lower motor efficiency orientation, in which a North pole of the second magnet at least partially overlaps a North pole of the first magnet, and a maximal motor efficiency orientation, in which there is no overlap of the North pole of the second magnet and the North pole of the first magnet.

In some such embodiments, at least one of the first and second extension tabs is adapted to move at least one of the first and second magnets between multiple lower motor efficiency orientations, wherein different ones of the multiple lower motor efficiency orientations have different degrees of overlap between the North pole of the second magnet and the North pole of the first magnet.

In some embodiments, in the maximal motor efficiency orientation, each North pole of the second magnets overlaps only a South pole of the first magnet, and each South pole of the second magnet overlaps only a North pole of the first magnet.

In some embodiments, the greater the overlap between the North poles of the first and second magnets, the lower the efficiency of the motor, and the greater the energy losses of the motor.

In some embodiments, each of the first and second magnets includes four sections having alternating poles.

In some embodiments, the at least two sections of each of the first and second magnets are equally sized.

In some embodiments, the first and second magnets are rare earth magnets.

In some embodiments, the shell is a circular shell.

In some embodiments, the circular shell has a diameter in the range of 5 mm to 60 mm, 5 mm to 50 mm, 5 mm to 40 mm, 5 mm to 30 mm, 5 mm to 25 mm, 5 mm to 20 mm, 5 mm to 15 mm, 5 mm to 12 mm, or 5 mm to 10 mm.

In some embodiments, the circular shell has a height in the range of 2 mm to 30 mm, 2 mm to 25 mm, 2 mm to 20 mm, 2 mm to 15 mm, 2 mm to 10 mm, 3 mm to 8 mm, or 4 mm to 6 mm.

In some embodiments, the circular shell has a diameter in the range of 7 mm to 9 mm and a height in the range of 4 mm to 5 mm.

In some embodiments, the circular shell has a diameter in the range of 5 mm to 12 mm and a height in the range of 2 mm to 8 mm. In some embodiments, the diameter of the shell is greater than the height of the shell.

In some embodiments, a ratio of the diameter of the shell to the height of the shell is at most 30:1, 25:1, 20:1, 15:1, 10:1, 8:1, 5:1, 4:1, 3:1, 2.5:1, 2:1, or 1.8:1.

In some embodiments, the ratio of the diameter of the shell to the height of the shell is at least 1.1:1, 1.2:1, 1.3:1, 1.4:1, 1.5:1, 1.6:1 or 1.7:1.

In some embodiments, the diameter of the shell is greater than the height of the shell, and a ratio of the diameter of the shell to the height of the shell is in the range of 1.1:1 to 6:1.

In some embodiments, the first extension tab is movable within the slot and the first magnet is rotatable about the axis and movable relative to the second magnet, only during a set-up mode of operation prior to activation of the vibration motor, and during an active mode of operation of the vibration motor, the first magnet is fixed relative to the second magnet.

In accordance with another embodiment of the present invention, there is provided a vibration motor, including:

a shell defining a cavity therein;

an axis disposed entirely within the cavity and being fixedly anchored to the shell;

first and second magnets, disposed about the axis in fixed orientations relative to the shell, each of the first and second magnets including at least two sections having alternating poles;

an unbalanced rotor, disposed on the axis between the first and the second magnets and being rotatable relative to the axis, the unbalanced rotor having a commutating electronic circuit disposed on a first surface thereof and electric coils disposed on a second surface thereof, opposed to the first surface, the electric coils adapted to receive current from the commutating electronic circuit;

an electric terminal disposed about the axis within the shell, the electric terminal including an electric circuit terminating in an electric lead extending out of the shell, and a plurality of brushes extending from the electrical terminal toward the unbalanced rotor and electrically engaging the commutating electronic circuit of the rotor, the plurality of brushes adapted to provide electric current, received via the electric lead, to the commutating electronic circuit,

wherein, in operation, DC current provided via the electric terminal and the brushes to the commutating electronic circuit causes polarizing of the coils, and attraction and repulsion of the polarized coils by the first and second magnets drives rotation of the rotor about the axis, and

wherein the first and second magnets are arranged within the shell such that at least one North pole of the first magnet at least partially overlaps at least one North pole of the second magnet, and the motor operates at less than maximal efficiency.

In some embodiments, the greater the overlap between the North poles of the first and second magnets, the lower the efficiency of the motor, and the greater the energy losses of the motor.

In some embodiments, each of the first and second magnets includes four sections having alternating poles, the four sections being equally sized.

In some embodiments, the first and second magnets are rare earth magnets.

In some embodiments, the shell is a circular shell.

In some such embodiments, the circular shell has a diameter in the range of 5 mm to 60 mm, 5 mm to 50 mm, 5 mm to 40 mm, 5 mm to 30 mm, 5 mm to 25 mm, 5 mm to 20 mm, 5 mm to 15 mm, 5 mm to 12 mm, or 5 mm to 10 mm.

In some such embodiments, the circular shell has a height in the range of 2 mm to 30 mm, 2 mm to 25 mm, 2 mm to 20 mm, 2 mm to 15 mm, 2 mm to 10 mm, 3 mm to 8 mm, or 4 mm to 6 mm.

In some embodiments, the circular shell has a diameter in the range of 5 mm to 12 mm and a height in the range of 2 mm to 8 mm.

In some embodiments, the diameter of the circular shell is greater than the height of the circular shell, and a ratio of the diameter of the shell to the height of the shell is in the range of 1.1:1 to 6:1.

### BRIEF DESCRIPTION OF THE FIGURES

The foregoing discussion will be understood more readily from the following detailed description of the invention, when taken in conjunction with the accompanying Figures (1A-8B), in which:

FIGS. 1A and 1B are, respectively, a perspective exploded view illustration and a perspective constructed illustration of an embodiment of a vibration motor according to an embodiment of the present invention;

FIG. 2 is a planar sectional illustration of the vibration motor of FIGS. 1A and 1B;

FIGS. 3A and 3B are top and bottom perspective illustrations of a rotor forming part of the vibration motor of FIGS. 1A to 2;

FIG. 4 is a schematic partially cut-away perspective illustration demonstrating magnetization of coils in the rotor of FIGS. 3A and 3B;

FIG. 5 is a schematic illustration of the effect of the polarity of magnets on the coils of FIGS. 4A and 4B;

FIGS. 6A, 6B, and 6C are schematic illustrations of three arrangements of the poles of magnets within the vibration motor of FIGS. 1A to 2;

FIGS. 7A and 7B are, respectively, a perspective view illustration of an embodiment of a vibration motor, and a perspective view illustration of magnets included in the vibration motor according to another embodiment of the present invention; and

FIGS. 8A and 8B are, respectively, a perspective view illustration of an embodiment of a vibration motor, and a perspective view illustration of magnets included in the vibration motor according to a further embodiment of the present invention.

### DESCRIPTION OF THE PREFERRED EMBODIMENTS

The principles of the inventive vibration motors, and specifically the vibration motors rotating using the force of magnetic fields, may be better understood with reference to the drawings and the accompanying description.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

In the context of the present specification and claims, the term “radially inward” is defined as moving toward the center of a circle, or being closer to the center of a circle than another object. Correspondingly, the term “radially outward” is defined as moving away from the center of a circle, or being further from the center of a circle than another object.

In the context of the present specification and claims, two objects are considered to “spatially overlap” if, when looking vertically from above the two objects, one of the objects is hidden by the other object. Stated differently, two objects “spatially overlap” if their projections onto a horizontal surface overlap.

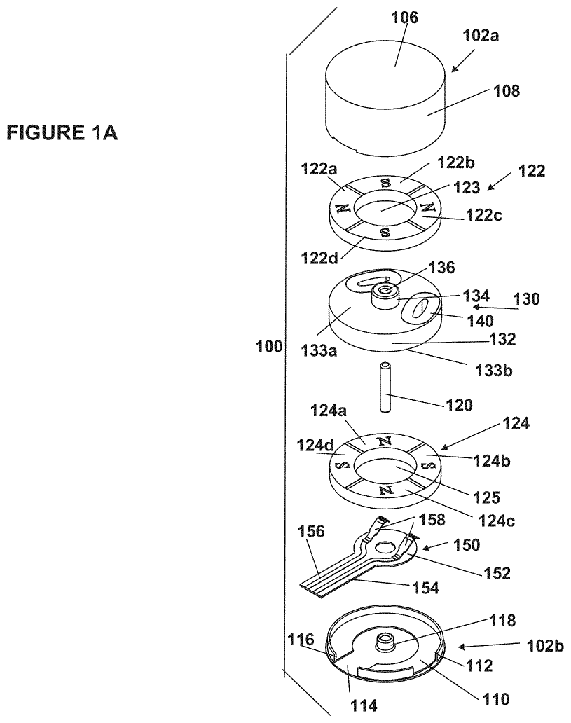

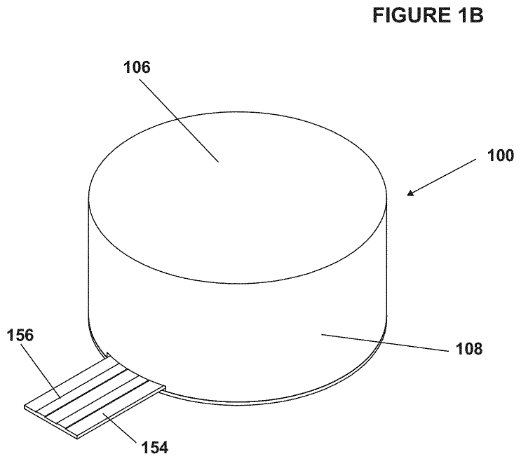

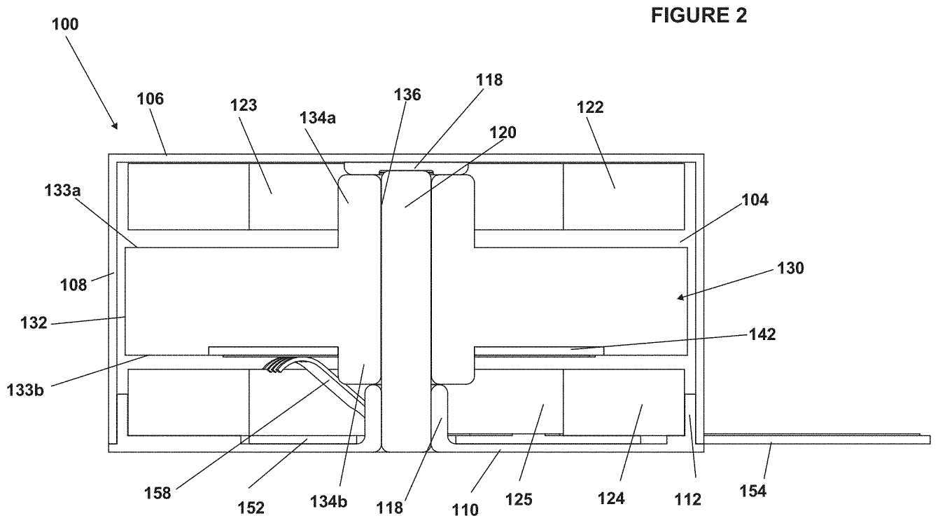

Reference is now made to FIGS. 1A and 1B, which are, respectively, a perspective exploded view illustration and a perspective constructed illustration of a vibration motor 100 according to an embodiment of the present invention, and to FIG. 2, which is a planar sectional illustration of vibration motor 100.

As seen, vibration motor 100 includes a first, upper, shell portion 102a, and second, lower shell portion 102b, which are attachable to form a shell defining a cavity, or a hollow, 104 therein. In some embodiments, shell portions 102a and 102b are such that motor 100 is substantially circular. The dimensions of the motor are defined by the dimensions of the shell.

In some such embodiments, motor 100, when constructed, has a diameter in the range of 5 mm to 60 mm, 5 mm to 50 mm, 5 mm to 40 mm, 5 mm to 30 mm, 5 mm to 25 mm, 5 mm to 20 mm, 5 mm to 15 mm, 5 mm to 12 mm, or 5 mm to 10 mm.

In some embodiments, motor 100, when constructed, has a height in the range of 2 mm to 30 mm, 2 mm to 25 mm, 2 mm to 20 mm, 2 mm to 15 mm, 2 mm to 10 mm, 3 mm to 8 mm, or 4 mm to 6 mm.

In some embodiments, motor 100, when constructed, has a diameter in the range of 7 mm to 9 mm and a height in the range of 4 mm to 5 mm.

In some embodiments, motor 100, when constructed, has a diameter in the range of 5 mm to 12 mm and a height in the range of 2 mm to 8 mm.

In some embodiments, the diameter of motor 100, when constructed, is greater than the height of the motor. In some such embodiments, a ratio of the diameter of the motor to the height of the motor is at most 30:1, 25:1, 20:1, 15:1, 10:1, 8:1, 5:1, 4:1, 3:1, 2.5:1, 2:1, or 1.8:1. In some embodiments, the ratio of the diameter of the motor to the height of the motor is at least 1.1:1, 1.2:1, 1.3:1, 1.4:1, 1.5:1, 1.6:1 or 1.7:1.

In some embodiments, the ratio of the diameter of the motor to the height of the motor is in the range of 1.1:1 to 6:1.

In some embodiments, upper shell portion 102a includes a generally circular upper wall 106, and a cylindrical side wall 108 extending downwardly therefrom.

In some embodiments, lower shell portion 102b includes a generally circular base 110, having ridges 112 extending upward therefrom along parts of the perimeter of base 110, ridges 112 adapted to engage an inner surface of cylindrical side wall 108 of the upper shell portion 102a, as seen clearly in FIG. 2. In some embodiments, an inner surface of circular base 110 includes a terminal receiving indentation 114, adapted to receive an electric terminal as described hereinbelow. In such embodiments, ridges 112 are interrupted at a portion 116 of the perimeter of circular base 110 which engages terminal receiving indentation 114, to facilitate passage of an electrical lead of the electric terminal, as described in further detail hereinbelow.

Disposed on inner surfaces of upper wall 106 of upper shell portion 102a and of circular base 110 of lower shell portion 102b, substantially at the centers thereof, are axis anchoring portions 118, adapted to fixedly anchor an axis 120 therebetween. As seen clearly in FIG. 2, axis 120 is disposed entirely within cavity 104, and does not extend outside of the shell of motor 100. Axis 120 is fixedly anchored between upper and lower shell portions 102a and 102b.

First and second annular magnets 122 and 124 are disposed about axis 120, in a fixed rotational orientation relative to upper and lower shell portions 102a and 102b. In some embodiments, magnets 122 and 124 may be fixed to the upper and lower shell portions using any suitable mechanism, including frictional engagement, adhesive, welding, soldering, use of mechanical fasteners, and the like. The diameters of central bores 123 and 125 of respective magnets 122 and 124 are equal to or larger than the diameter of axis 120, which may be in the range of 0.1 mm to 3 mm.

Each of magnets 122 and 124 includes a plurality of magnetic sections, having alternating polarities. For example, in FIG. 1A, magnet 122 is illustrated as having four sections, 122a, 122b, 122c, and 122d, having alternating polar arrangements. As such, section 122a is a north pole, section 122b is a south pole, section 122c is another north pole, and section 122d is another south pole. Similarly, magnet 124 is illustrated as having four sections, 124a, 124b, 124c, and 124d, having alternating polar arrangements. As such, section 124a is a north pole, section 124b is a south pole, section 124c is another north pole, and section 124d is another south pole. As explained in detail hereinbelow, the relative orientation of the poles of magnets 122 and 124, within shell portions 102a and 102b, determines the efficiency of the motor 100.

Although magnets 122 and 124 are illustrated as having four sections, including two north poles and two south poles, the magnets may include a different even number of sections, depending on the dimensions of a specific implementation. In the illustrated embodiment, the four sections of each of magnets 122 and 124 are equally sized.

In some embodiments, magnets 122 and 124 are rare earth magnets, such as neodymium magnets or samarium-cobalt magnets.

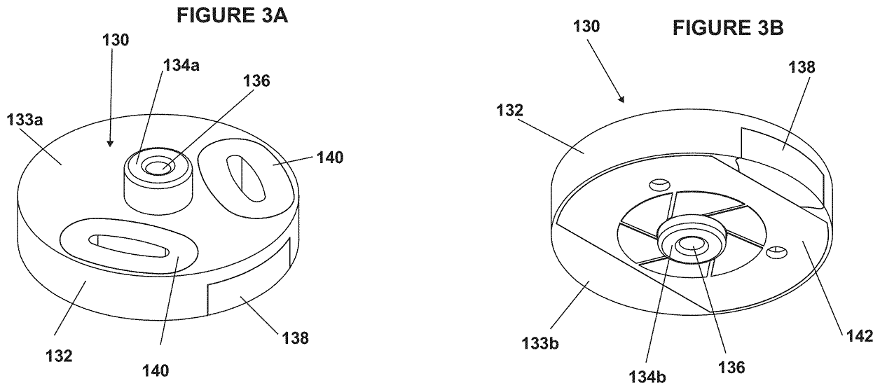

An unbalanced rotor 130 is disposed on axis 120, between magnets 122 and 124, and is rotatable about axis 120. Referring now additionally to FIGS. 3A and 3B, which are top and bottom perspective illustrations of rotor 130, it is seen that rotor 130 includes a disc shaped body 132 having an upper surface 133a and a lower surface 133b. Extending longitudinally outward from upper surface 133a, generally at the center thereof, is a cylindrical upper cowl portion 134a, and extending longitudinally outward from lower surface 133b, generally at the center thereof, is a cylindrical lower cowl portion 134b. A central bore 136 is formed by a bore in disc shaped body 132, together with bores of upper and lower cowl portions 134a and 134b. Central bore 136 receives axis 120 therein, as shown clearly in FIG. 2.

An eccentric weight 138 is disposed in one side of disc shaped body 132, the eccentric weight causing the rotor to be unbalanced, and to generate vibration when rotating about axis 120.

As seen clearly in FIG. 3A, a pair of electric coils 140, which are disposed within suitable indentations formed in disc shaped body 132. In some embodiments, the electric coils 140 are flush with upper surface 133a, and, in the illustrated embodiment, are oval in shape. In some embodiments, such as that illustrated in FIG. 3A, the coils 140 are disposed on opposing sides of eccentric weight 138.

A commutating electronic circuit 142, shown clearly in FIG. 3B, is disposed in a suitable indentation on the opposing side of disc shaped body 132, and is flush with lower surface 133b. Commutating electronic circuit 142 is in electric communication with coils 140, and is adapted to provide electric current thereto.

Returning to FIG. 1A, it is seen that motor 100 further includes an electric terminal 150 disposed within terminal receiving indentation 114 of lower shell portion 102b. An annular body portion 152 of electric terminal 150 is disposed about axis 120 and axis anchoring portion 118, and an elongate electric lead 154 extends radially outwardly from annular body portion 152 and out of lower shell portion 102b, via interrupted portion 116 thereof. An electric circuit 156 extends along electric lead 154 and annular body portion 152, the electric circuit 156 terminating in a plurality of brushes 158 extending from electric terminal 150 toward rotor 130. Brushes 158 are adapted to physically and electrically engage commutating electronic circuit 142 of rotor 130. As explained in further detail hereinbelow, brushes 158 are adapted to provide electric current, received via electric circuit 156 and electric lead 154, to commutating electronic circuit 142 for charging of coils 140.

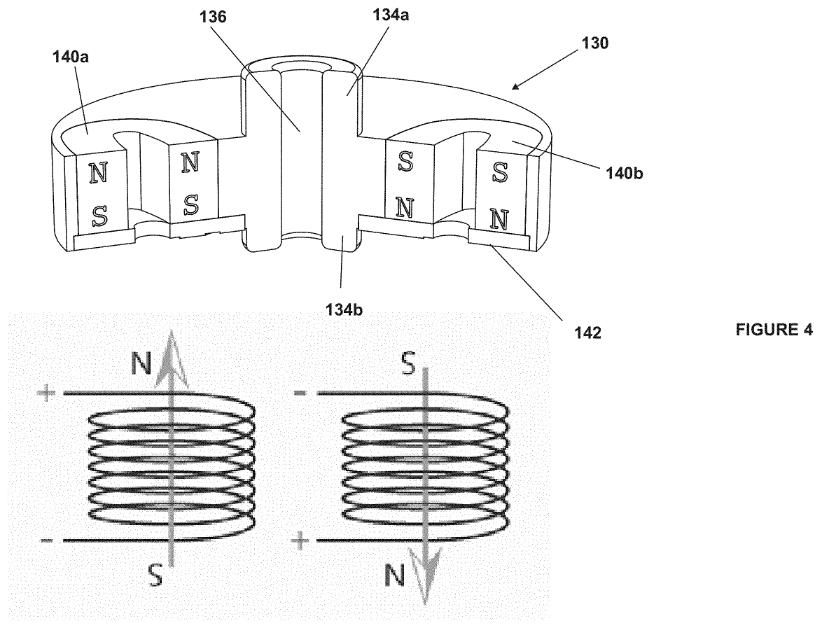

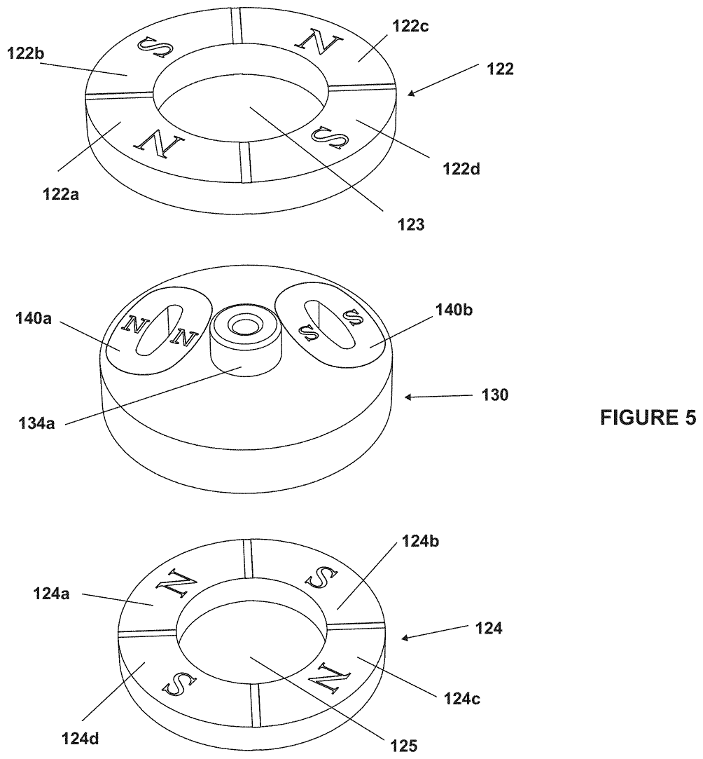

In use, DC current is provided from a power source (not shown), via electric lead 154 and electric circuit 156, to brushes 158. The brushes 158 engage the commutating electronic circuit 142 and provide electrical current thereto, and from commutating electronic circuit 142 the current is provided to coils 140. As seen in FIG. 4, when electric power is provided to coils 140, the coils generate magnetic fields and become polarized. In the present invention, the coils are connected in opposing electrical directions, and as such generate magnetic fields in opposing directions. As seen in FIGS. 4 and 5, a first coil indicated by reference numeral 140a has an upper portion polarized as a North pole and a lower portion polarized as a South pole, whereas the second coil indicated by reference numeral 140b has an upper portion polarized as a South pole and a lower portion polarized as a North pole.

The polarized coils and the regions thereunder are then attracted to sections of magnets 122 and 124 having opposite polarization, and are repelled from sections of magnets 122 and 124 having the same polarization as the coil, which magnetic attraction and repulsion forces drive rotation of the rotor 130.

As the rotor 130 rotates, brushes 158 engage different areas of commutating circuit 142 which reverse the polarization of coils 140. The reversal of polarization further drives rotation of rotor 130, by coils 140 now being attracted to the next sections of magnets 122 and 124, and repelled by the sections of magnets 122 and 124 to which the coils are currently adjacent. This process or reversal of polarization of the coils repeats itself as long as current is provided to the coils for polarizing thereof which drives rotational motion of the rotor 130.

In devices that include a single magnet, the rotation of the rotor 130 is driven by that single magnet and by one polarized portion of each coil (upper or lower portion, depending on the location of the magnet relative to the rotor), and the efficiency of the motor is fixed. By contrast, in the present invention, both magnets 122 and 124 are polarized and attract/repel the polarized coils 140, and as such impact the rotation of rotor 130, as illustrated in FIG. 5.

As seen in FIG. 5, a first coil, indicated as 140a, has an upper portion polarized as a North pole and lower portion polarized as a South pole. The upper portion of the coil is attracted to South polarized section 122b and is repelled from North polarized section 122a of upper magnet 122, while at the same time the lower portion of the coil 140a is attracted to North polarized section 124a and is repelled from South polarized section 124d of lower magnet 124. Similarly, in second coil 140, which has an upper portion polarized as a South pole and a lower portion polarized as a North pole, the upper and lower portions of the coil are simultaneously attracted in one direction and repelled in the opposing direction. Thus, in the arrangement of the magnets shown in FIG. 5, there is a double magnetic force driving rotation of the rotor than there would be if a single magnet was used.

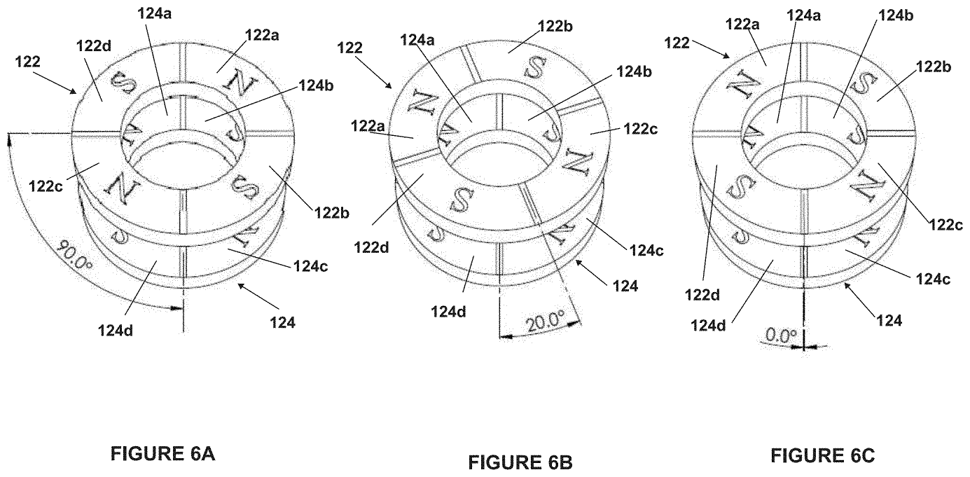

Because rotation of rotor 130 is affected by the magnetic forces of both magnets 122 and 124, the orientation of the polarized sections of the magnets greatly impacts the speed at which the rotor rotates, and the efficiency of the motor. FIGS. 6A, 6B, and 6C are schematic illustrations of three arrangements of the poles of magnets 122 and 124, which result in different rotation speeds of rotor 130 and in different efficiencies of motor 100.

FIGS. 6A, 6B, and 6C show magnets 122 and 124 each having four sections, the four sections being alternately polarized, as described hereinabove.

In the arrangement shown in FIG. 6A, the North poles of upper magnet 122 spatially overlap the South poles of lower magnet 124. Similarly, the South poles of upper magnet 122 spatially overlap the North poles of lower magnet 124. In magnets having four sections, this situation occurs when there is an axial rotation of 90 degrees between the two magnets. In this arrangement, because coils are oppositely polarized in the upper and lower portions thereof, the magnetic fields applied by both the upper and lower magnets drive rotation of the rotor, as explained hereinabove with respect to FIG. 5. As such, in this arrangement, the motor 100 runs at maximal efficiency. In some embodiments, where there is no spatial overlap between North poles of one magnet and North poles of the other magnet, the frequency of rotation of rotor 130 is in the range of 50 Hz to 500 Hz.

In the arrangement shown in FIG. 6C, the North poles of upper magnet 122 spatially overlap the North poles of lower magnet 124. Similarly, the South poles of upper magnet 122 spatially overlap the South poles of lower magnet 124. In magnets having four sections, this situation occurs when there is an axial rotation of 0 degrees between the two magnets. In this arrangement, because coils are oppositely polarized in the upper and lower portions thereof, while the magnetic field applied by one of the magnets repels the one portion of the coil, the magnetic field applied by the other magnet attracts the opposing portion of the coil. For example, assume that a coil having an upper portion polarized as North and a lower portion polarized as South is disposed between sections 122b and 124b of the magnets in FIG. 6C. The upper portion of the coil, polarized as North, would be attracted to the south pole of section 122b of upper magnet 122. By contrast, the lower portion of the coil, polarized as South, would be repelled from the south pole of section 124b of the lower magnet 124. Since the magnetic fields of the two magnets are of the same force, in this arrangement there would be no rotation of rotor 130, and stalling of motor 100. Stated differently, this is the most ineffective arrangement of the magnets 122 and 124.

In the arrangement shown in FIG. 6B, a portion of each of the North poles of upper magnet 122 spatially overlaps a portion of one of the North poles of lower magnet 124. Similarly, a portion of each of the South poles of upper magnet 122 spatially overlaps a portion of one the South poles of lower magnet 124. In the illustrated embodiment, the magnets have an axial rotation of 20 degrees between them. In this arrangement, the opposite polarization between the upper and lower portions of the coils and the attraction to and repulsion from magnets 122 and 124, results in operation of the motor at less than maximal efficiency. This is due to the fact that part of the forces applied by the magnets, due to the overlap, are in the direction opposite to the direction of rotation. The reason the motor does not stall in this orientation is that the part of the force applied in the direction of rotation, is greater that the part of the force applied in the opposite direction.

It is a particular feature of the embodiment of FIGS. 1A to 2, that the magnets 122 and 124 are arranged within shell 102, in a fixed rotational orientation, such that at least one North pole of magnet 122 at least partially overlaps at least one North pole of magnet 124, and motor 100 operates at less than maximal efficiency.

The Applicants have discovered that the greater the degree of spatial overlap between identical poles of magnets 122 and 124, the lower the efficiency of motor 100, and the greater the energy losses of the motor. As such, the Applicants have identified that the efficiency of motor 100 is inversely correlated to the degree of spatial overlap of same polarization sections of magnets 122 and 124. Similarly, the greater the degree of spatial overlap between North poles of magnets 122 and 124, the lower the frequency of rotation of the rotor 130. In some embodiments, the degree of spatial overlap may be correlated to the motor efficiency, for example using a formula linking the angle of axial rotation between the magnets or the percentage of overlap between same polarization sections to the motor efficiency.

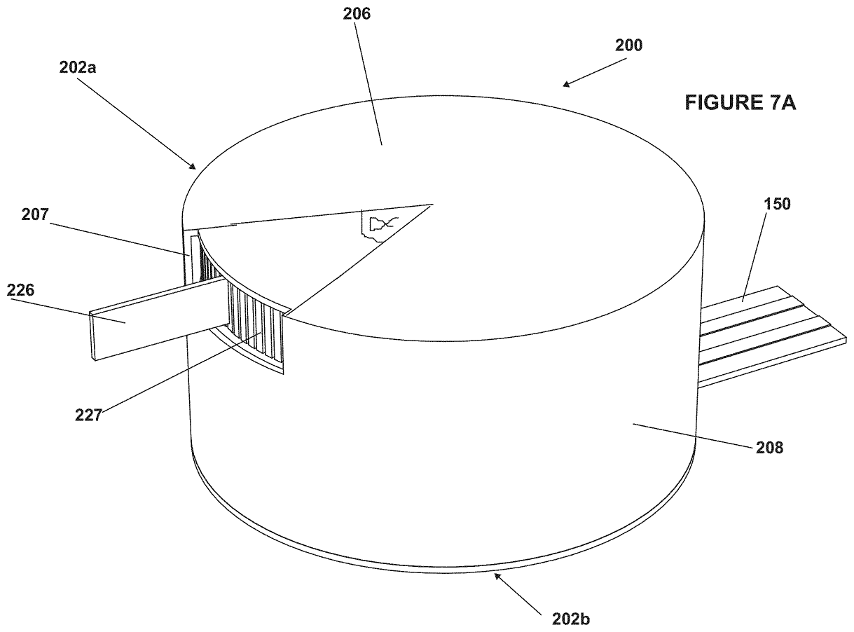

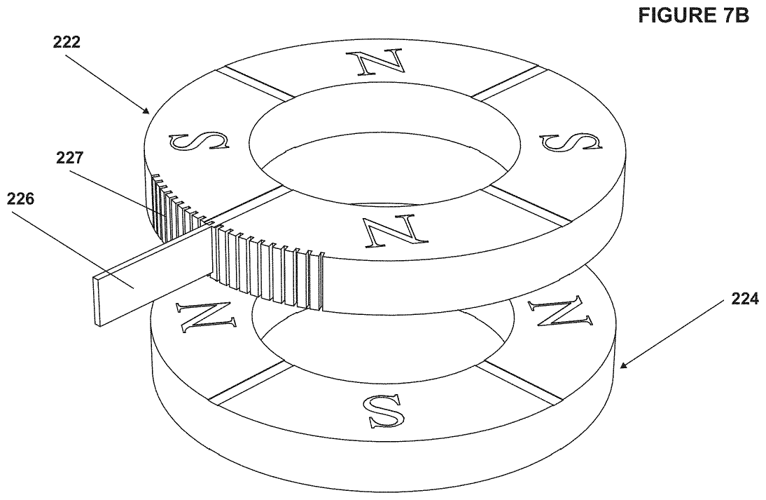

References is now made to FIGS. 7A and 7B, which are, respectively, a perspective view illustration of an embodiment of a vibration motor 200, and a perspective view illustration of magnets 222 and 224 included in the vibration motor 200 according to another embodiment of the present invention. Vibration motor 200 is substantially similar to motor 100 described hereinabove with respect to FIGS. 1A to 2, and differs therefrom only in aspects explicitly disclosed hereinbelow. As such, vibration motor 200 includes axis 120, rotor 130, and electric terminal 150, as described hereinabove with respect to FIGS. 1A to 2.

Vibration motor 200 includes a lower shell portion 202b substantially as described hereinabove with respect to lower shell portion 102b of FIGS. 1A to 2. As seen clearly in FIG. 7A, upper shell portion 202a of vibration motor 200 includes generally circular upper wall 206, and a cylindrical side wall 208 extending downwardly therefrom. Cylindrical side wall 208 has formed therein, adjacent upper wall 206, a slot 207, spanning a partial arc of cylindrical side wall 208. In some embodiments, a leaf 209 extends radially inwardly from cylindrical side wall 208, at one edge of slot 207.

As seen clearly in FIG. 7B, magnets 222 and 224 of motor 200 are divided into sections which are alternately polarized, as described hereinabove with respect to magnets 122 and 124 of FIGS. 1A to 2. Second, lower magnet 224 is disposed in a fixed rotational orientation relative to the shell portions 202a and 202b, substantially as described hereinabove with respect to magnet 124 of FIGS. 1A to 2. First, upper magnet 222, has fixedly attached thereto an extension tab 226.

As seen in FIG. 7A, extension tab 226 extends radially outwardly via slot 207 and is accessible to a user holding the motor 200.

It is a particular feature of the present invention that, during a set-up mode of operation, prior to activation of motor 200, a user may use extension tab 226 to rotate magnet about the axis 222, relative to upper shell 202a and relative to magnet 224, thereby to change the relative rotational orientation of the polarized sections of magnets 222 and 224. As discussed at length hereinabove with respect to FIGS. 6A to 6C, changing the relative rotational orientations of the polarized sections of magnets 222 and 224 changes the efficiency of operation of motor 200. As such, by moving extension tab 226, the user may actively impact and determine the efficiency of operation of motor 200.

The user may move the magnet 222 between a first, maximal efficiency orientation, in which the magnets 222 and 224 are arranged as illustrated in FIG. 6A, and one or more lower efficiency orientation, in which the magnets have at least partial overlap between same-polarization sections, as illustrated in FIG. 6C. In some embodiments which facilitate multiple lower efficiency orientations, different ones of the multiple lower efficiency orientations have different degrees of overlap between same polarization sections, and/or different motor efficiencies.

In some embodiments, magnet 222 may have steps or slots 227 on at least a portion of an exterior surface thereof. For example, steps 227 may be disposed adjacent extension tab 226. Leaf 209 of slot 207 is adapted to engage steps 227, and to provide, to the user, an indication of the degree to which the user is moving magnet 222.

The extent to which the user can move magnet 222, and can impact the relative rotational orientations of magnets 222 and 224, is restricted by the length of the arc of slot 207. In some embodiments, the arc of slot 207 is opposite a central angle, indicated in FIG. 7A as a, having a range of 5 to 90 degrees, 10 to 75 degrees, 20 to 60 degrees, 20 to 50 degrees, or 30 to 40 degrees. In some embodiments, the length of the arc of slot 207 is not greater than the arcuate length of a section of magnet 222. For example, in the illustrated embodiment, in which magnet 222 is divided into four equal sections, each spanning 90 degrees of the ring of the magnet, the arc of slot 207 may be opposite a central angle not greater than 90 degrees.

Once the user sets the relative arrangement of magnets 222 and 224, during an active mode of operation of the motor 200, the motor operates as described hereinabove with respect to motor 100 of FIGS. 1A to 2. During the active mode of operation, the magnets 222 and 224 are at fixed locations relative to each other.

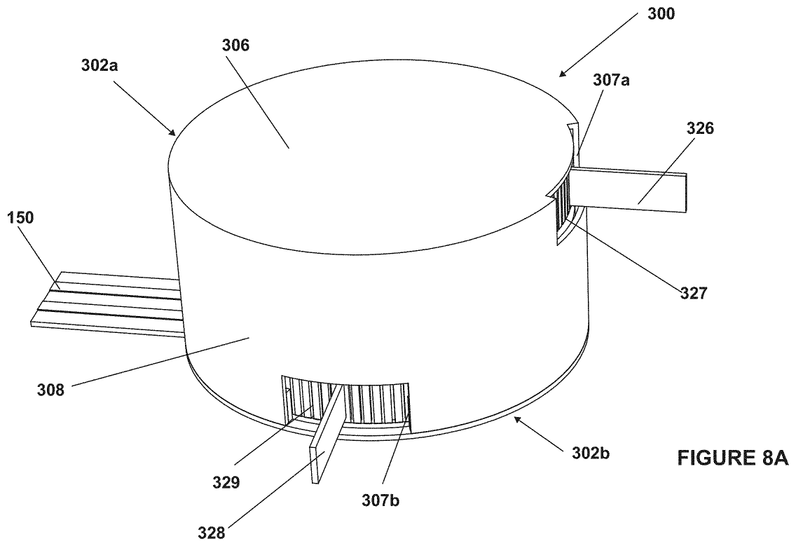

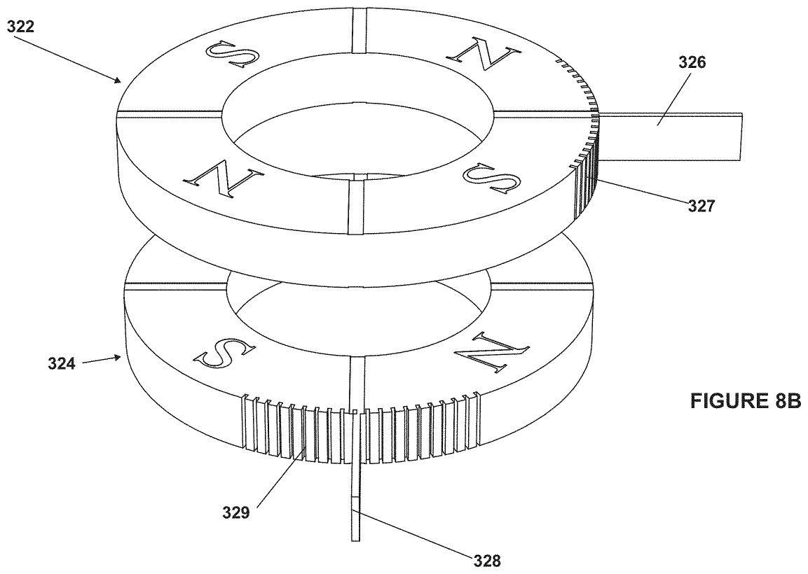

Reference is now made to FIGS. 8A and 8B, which are, respectively, a perspective view illustration of an embodiment of a vibration motor 300, and a perspective view illustration of magnets 322 and 324 included in the vibration motor according to a further embodiment of the present invention.

Vibration motor 300 is substantially similar to motor 100 described hereinabove with respect to FIGS. 1A to 2, and differs therefrom only in aspects explicitly disclosed hereinbelow. As such, vibration motor 300 includes axis 120, rotor 130, and electric terminal 150, as described hereinabove with respect to FIGS. 1A to 2.

Vibration motor 300 includes a lower shell portion 302b substantially as described hereinabove with respect to lower shell portion 102b of FIGS. 1A to 2. As seen clearly in FIG. 7A, upper shell portion 302a of vibration motor 300 includes generally circular upper wall 306, and a cylindrical side wall 308 extending downwardly therefrom. Cylindrical side wall 308 has formed therein an upper slot 307a disposed adjacent upper wall 306, and a lower slot 307b disposed adjacent lower shell portion 302b. Each of slots 307a and 307b spans a partial arc of cylindrical side wall 308. In some embodiments, a leaf 309a extends radially inwardly from cylindrical side wall 308, at one edge of slot 307a. In some embodiments, a leaf 309b extends radially inwardly from cylindrical side wall 308, at one edge of slot 307b.

As seen clearly in FIG. 8B, magnets 322 and 324 of motor 300 are divided into sections which are alternately polarized, as described hereinabove with respect to magnets 122 and 124 of FIGS. 1A to 2. First, upper magnet 322, has fixedly attached thereto a first extension tab 326, and second, lower magnet 324 has fixedly attached thereto a second extension tab 328.

As seen in FIG. 8A, extension tab 326 extends radially outwardly via slot 307a and extension tab 328 extends radially outwardly via slot 307b. Both extension tabs 326 and 328 are accessible to a user holding the motor 300.

It is a particular feature of the present invention that, during a set-up mode of operation, prior to activation of motor 300, a user may use extension tab 326 to move magnet 322 relative to upper shell 302a and relative to magnet 324, and/or may use extension tab 328 to move magnet 324 relative to upper shell 302a and relative to magnet 322, thereby to change the relative rotational orientation of the polarized sections of magnets 322 and 324. As discussed at length hereinabove with respect to FIGS. 6A to 6C, changing the relative rotational orientations of the polarized sections of magnets 322 and 324 changes the efficiency of operation of motor 300. As such, by moving one or both of extension tabs 326 and 328, the user may actively impact and determine the efficiency of operation of motor 300.

The user may move the magnets 322 and/or 324 between a first, maximal efficiency orientation, in which the magnets 322 and 324 are arranged as illustrated in FIG. 6A, and one or more lower efficiency orientation, in which the magnets have at least partial overlap between same-polarization sections, as illustrated in FIG. 6B. In some embodiments which facilitate multiple lower efficiency orientations, different ones of the multiple lower efficiency orientations have different degrees of overlap between same polarization sections, and/or different motor efficiencies.

In some embodiments, magnet 322 may have steps or slots 327 on at least a portion of an exterior surface thereof. For example, steps 327 may be disposed adjacent extension tab 326. Leaf 309a of slot 307a is adapted to engage steps 327, and to provide to the user an indication of the degree to which the user is moving magnet 322. Similarly, magnet 324 may have steps or slots 329 on at least a portion of an exterior surface thereof. For example, steps 329 may be disposed adjacent extension tab 328. Leaf 309b of slot 307b is adapted to engage steps 329, and to provide to the user an indication of the degree to which the user is moving magnet 324.

The extent to which the user can move magnets 322 and 324, and can impact the relative rotational orientations of magnets 322 and 324, is restricted by the respective lengths of the arcs of slots 307a and 307b. In some embodiments, the arc of slot 307a is opposite a central angle, indicated in FIG. 8A as a, having a range of 5 to 90 degrees, 10 to 75 degrees, 20 to 60 degrees, 20 to 50 degrees, or 30 to 40 degrees. In some embodiments, the length of the arc of slot 307a is not greater than the arcuate length of a section of magnet 322. For example, in the illustrated embodiment, in which magnet 322 is divided into four equal sections, each spanning 90 degrees of the ring of the magnet, the arc of slot 307a may be opposite a central angle not greater than 90 degrees. Similarly, in some embodiments, the arc of slot 307b is opposite a central angle, indicated in FIG. 8A as β, having a range of 5 to 90 degrees, 10 to 75 degrees, 20 to 60 degrees, 20 to 50 degrees, or 30 to 40 degrees. In some embodiments, the length of the arc of slot 307b is not greater than the arcuate length of a section of magnet 324. For example, in the illustrated embodiment, in which magnet 324 is divided into four equal sections, each spanning 90 degrees of the ring of the magnet, the arc of slot 307b may be opposite a central angle not greater than 90 degrees.

The arcs of slots 307a and 307b may be of the same length, but may also be of different lengths.

As seen in FIG. 8A, slots 307a and 307b need not be disposed vertically above one another, within cylindrical side wall 308. However, in other embodiments, slots 307a and 307b may be disposed one above the other within wall 308, or may have partial overlap therebetween.

Once the user sets the relative arrangement of magnets 322 and 324, during an active mode of operation of motor 300, the motor operates as described hereinabove with respect to motor 100 of FIGS. 1A to 2. During the active mode of operation, the magnets 322 and 324 are fixed relative to each other.

It will be appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

1. A vibration motor, comprising:
a shell defining a cavity therein;
an axis disposed entirely within said cavity and fixedly anchored to said shell;
a first magnet, disposed about said axis within said cavity and being rotationally movable relative to said shell, said first magnet including at least two sections having alternating poles;
a second magnet, disposed about said axis within said cavity, said second magnet including at least two sections having alternating poles;
a first extension tab, fixedly attached to said first magnet and extending out of said shell via a slot in said shell;
an unbalanced rotor, disposed on said axis between said first and said second magnets and being rotatable relative to said axis, said unbalanced rotor having a commutating electronic circuit disposed on a first surface thereof and electric coils disposed on a second surface thereof, opposed to said first surface, said electric coils adapted to receive current from said commutating electronic circuit;
an electric terminal disposed about said axis within said cavity, said electric terminal including an electric circuit terminating in an electric lead extending out of said shell, and a plurality of brushes extending from said electrical terminal toward said unbalanced rotor and electrically engaging said commutating electronic circuit of said rotor, said plurality of brushes adapted to provide electric current, received via said electric lead, to said commutating electronic circuit,
wherein said first extension tab is movable within said slot, such that moving said tab causes rotation of said first magnet about said axis and changes a rotational position of said first magnet relative to said second magnet, thereby to change the efficiency of operation of said motor, and
wherein, in operation, DC current provided via said electric terminal and said brushes to said commutating electronic circuit causes polarizing of said coils, and attraction and repulsion of said polarized coils by said first and second magnets drives rotation of said rotor about said axis.

2. The vibration motor of claim 1, wherein said second magnet is in a fixed rotational position relative to said shell.

3. The vibration motor of claim 1, wherein said first extension tab is adapted to move said first magnet between a lower motor efficiency orientation, in which a North pole of said first magnet at least partially overlaps a North pole of said second magnet, and a maximal motor efficiency orientation, in which there is no overlap of said North pole of said first magnet and said North pole of said second magnet.

4. The vibration motor of claim 3, wherein said first extension tab is adapted to move said first magnet between multiple lower motor efficiency orientations, wherein different ones of said multiple lower motor efficiency orientations have different degrees of overlap between said North pole of said second magnet and said North pole of said first magnet.

5. The vibration motor of claim 1, wherein,
wherein said second magnet is rotationally movable relative to said shell and relative to said first magnet.

6. The vibration motor of claim 5, further comprising a second extension tab, fixedly attached to said second magnet and extending out of said shell via a second slot in said shell,
wherein said first and second extension tabs are movable within said first and second slots, such that moving at least one of said first and second tabs causes relative movement of at least one of said first and second magnets and changes a relative position of said first and second magnets, thereby to change the efficiency of operation of said motor.

7. The vibration motor of claim 6, wherein at least one of said first and second extension tabs is adapted to move at least one of said first and second magnets between a lower motor efficiency orientation, in which a North pole of said second magnet at least partially overlaps a North pole of said first magnet, and a maximal motor efficiency orientation, in which there is no overlap of said North pole of said second magnet and said North pole of said first magnet.

8. The vibration motor of claim 7, wherein at least one of said first and second extension tabs is adapted to move at least one of said first and second magnets between multiple lower motor efficiency orientations, wherein different ones of said multiple lower motor efficiency orientations have different degrees of overlap between said North pole of said second magnet and said North pole of said first magnet.

9. The vibration motor of claim 3, wherein in said maximal motor efficiency orientation, each North pole of said second magnets overlaps only a South pole of said first magnet, and each South pole of said second magnet overlaps only a North pole of said first magnet.

10. The vibration motor of claim 1, wherein each of said first and second magnets includes four sections having alternating poles.

11. The vibration motor of claim 1, wherein said at least two sections of each of said first and second magnets are equally sized.

12. The vibration motor of claim 1, wherein said first and second magnets are rare earth magnets.

13. The vibration motor of claim 1, wherein said shell has a diameter in the range of 5 mm to 12 mm and a height in the range of 2 mm to 8 mm, and a ratio of said diameter of said shell to said height of said shell is in the range of 1.1:1 to 6:1.

14. (canceled)

15. The vibration motor of claim 1, wherein said first extension tab is movable within said slot and said first magnet is movable relative to said second magnet, only during a set-up mode of operation prior to activation of said vibration motor, and during an active mode of operation of said vibration motor, said first magnet is fixed relative to said second magnet.

16. A vibration motor, comprising:
a shell defining a cavity therein;
an axis disposed entirely within said cavity and being fixedly anchored to said shell;
first and second magnets, disposed about said axis in fixed orientations relative to said shell, each of said first and second magnets including at least two sections having alternating poles;
an unbalanced rotor, disposed on said axis between said first and said second magnets and being rotatable relative to said axis, said unbalanced rotor having a commutating electronic circuit disposed on a first surface thereof and electric coils disposed on a second surface thereof, opposed to said first surface, said electric coils adapted to receive current from said commutating electronic circuit;
an electric terminal disposed about said axis within said shell, said electric terminal including an electric circuit terminating in an electric lead extending out of said shell, and a plurality of brushes extending from said electrical terminal toward said unbalanced rotor and electrically engaging said commutating electronic circuit of said rotor, said plurality of brushes adapted to provide electric current, received via said electric lead, to said commutating electronic circuit,
wherein, in operation, DC current provided via said electric terminal and said brushes to said commutating electronic circuit causes polarizing of said coils, and attraction and repulsion of said polarized coils by said first and second magnets drives rotation of said rotor about said axis, and
wherein said first and second magnets are arranged within said shell such that at least one North pole of said first magnet at least partially overlaps at least one North pole of said second magnet, and said motor operates at less than maximal efficiency.

17. The vibration motor of claim 16, wherein each of said first and second magnets includes four sections having alternating poles, said four sections being equally sized.

18. The vibration motor of claim 16, wherein said first and second magnets are rare earth magnets.

19. The vibration motor of claim 16, wherein said shell has a diameter in the range of 5 mm to 12 mm and a height in the range of 2 mm to 8 mm and a ratio of said diameter of said shell to said height of said shell is in the range of 1.1:1 to 6:1.

20. (canceled)

21. A vibration motor, comprising:
a shell defining a cavity therein;
an axis disposed entirely within said cavity and fixedly anchored to said shell;
a first magnet, disposed about said axis within said cavity and being rotationally movable relative to said shell, said first magnet including at least two sections having alternating poles;
a second magnet, disposed about said axis within said cavity, said second magnet including at least two sections having alternating poles;
a first extension tab, fixedly attached to said first magnet and extending out of said shell via a slot in said shell;
an unbalanced rotor, disposed on said axis between said first and said second magnets and being rotatable relative to said axis, said unbalanced rotor having a commutating electronic circuit disposed on a first surface thereof and electric coils disposed on a second surface thereof, opposed to said first surface, said electric coils adapted to receive current from said commutating electronic circuit;
an electric terminal disposed about said axis within said cavity, said electric terminal including an electric circuit terminating in an electric lead extending out of said shell, and a plurality of brushes extending from said electrical terminal toward said unbalanced rotor and electrically engaging said commutating electronic circuit of said rotor, said plurality of brushes adapted to provide electric current, received via said electric lead, to said commutating electronic circuit,
wherein, in a set-up mode of operation prior to activation of said vibration motor, said first extension tab is movable within said slot, such that moving said tab causes rotation of said first magnet about said axis and changes a rotational position of said first magnet relative to said second magnet, thereby to change the efficiency of operation of said motor, and in an active mode of operation of said vibration motor, following activation thereof, said first extension tab is fixed within said slot and said first magnet is fixed relative to said second magnet,
wherein, in operation, DC current provided via said electric terminal and said brushes to said commutating electronic circuit causes polarizing of said coils, and attraction and repulsion of said polarized coils by said first and second magnets drives rotation of said rotor about said axis.

22. The vibration motor of claim 7, wherein in said maximal motor efficiency orientation, each North pole of said second magnets overlaps only a South pole of said first magnet, and each South pole of said second magnet overlaps only a North pole of said first magnet.
